(19) United States
(12) Patent Application Publication
(10) Pub. No.: US 2005/0000330 A1
(43) Pub. Date: Jan. 6, 2005

(54) Adjustable blind trimming apparatus and method of operating the same

(76) Inventor: William J. Schimmels, Oconomowoc, WI (US)

Correspondence Address: MICHAEL BEST & FRIEDRICH, LLP, 100 E WISCONSIN AVENUE, MILWAUKEE, WI, 53202, US

(21) Appl. No.: 10/610,685

(22) Filed: Jul. 1, 2003

(51) Int. Cl. B26D 1/00

(52) U.S. Cl. 83/13; 83/613

(57) ABSTRACT

A blind trimming apparatus and method of trimming blinds. The blind trimming apparatus includes a frame, a first pair of opposable cutting dies, at least one of which is moveable relative to the frame between a retracted position and an extended position, a second pair of opposable cutting dies, at least one of which is moveable relative to the frame between a retracted position and an extended position, and a carriage supported by the frame and supporting the second pair of opposable cutting dies. The carriage is moveable with respect to the first pair of opposable cutting dies to vary the distance between the first pair of opposable cutting dies in the extended position and the second pair of opposable cutting dies in the extended position.

### FIELD OF THE INVENTION

The present invention relates to an apparatus and a method of trimming blinds.

### BACKGROUND OF THE INVENTION

Conventional blinds generally include a headrail, a bottom rail, two or more ladders extending between the headrail and bottom rail, and a number of slats supported by the ladders. Conventional windows are generally manufactured in a number of nonstandard sizes. Therefore, blinds often are custom made to fit specific windows. Alternatively, blinds can be manufactured in a number of standard sizes and can be trimmed to fit specific windows. In these cases, a blind trimming apparatus is commonly used to trim one or more of the headrail, the bottom rail, and the slats.

### SUMMARY OF THE INVENTION

Conventional blinds generally have different vertical lengths or “drops” that correspond to the height of the window. Generally, taller windows require blinds having a longer drop and shorter windows require blinds having a shorter drop. Blinds having a longer drop generally include a larger number of slats than blinds having a shorter drop. Additionally, blind slats are made of a number of different materials (e.g., aluminum, wood, plastics, vinyl, and the like) and each of the materials generally has a different thickness. During blind trimming, the blind slats are often bunched or stacked together and inserted into a cutting recess. Depending upon the type of material and the number of slats, the size of the stacks can vary significantly. Therefore, for a single blind trimming apparatuses to accommodate different types and sizes of blinds, the blind trimming apparatus must be able to accommodate both large stacks of blinds and small stacks of blinds.

Additionally, during blind trimming, it is highly desirable to trim the headrail, bottom rail, and the slats simultaneously in a single cutting action to ensure that the headrail, bottom rail, and slats are similarly sized. Moreover, the ladders connect the headrail, bottom rail, and the slats, making it difficult to separate the headrail, the bottom rail, and the slats for separate trimming operations.

The present invention generally provides a blind trimming apparatus having a first pair of opposable cutting dies for cutting the head rail, a second pair of opposable cutting dies for cutting the blind slats, and a third pair of opposable cutting dies for cutting the bottom rail. The position of the second pair of opposable cutting dies is adjustable with respect to the positions of the first and third pairs of opposable cutting dies to accommodate large and small stacks of slats.

In one embodiment, the invention provides a blind trimming apparatus comprising a frame and a first pair of opposable cutting dies, at least one of which is moveable relative to the frame between a retracted position, in which the first pair of opposable cutting dies are spaced-apart, and an extended position, in which the first pair of opposable cutting dies are shearingly engageable. The blind trimming apparatus further comprises a second pair of opposable cutting dies, at least one of which is moveable relative to the frame between a retracted position, in which the second pair of opposable cutting dies are spaced-apart, and an extended position, in which the second pair of opposable cutting dies are shearingly engageable and spaced from the first pair of opposable cutting dies when the first pair of opposable cutting dies are in the extended position. The blind trimming apparatus also comprises a carriage supported by the frame and supporting the second pair of opposable cutting dies. The carriage is moveable with respect to the first pair of opposable cutting dies to vary the distance between the first pair of opposable cutting dies in the extended position and the second pair of opposable cutting dies in the extended position.

In another embodiment, the present invention provides a blind trimming apparatus comprising a frame and a first pair of opposable cutting dies, at least one of which is moveable relative to the frame between a retracted position, in which the first pair of opposable cutting dies are spaced-apart, and an extended position, in which the first pair of opposable cutting dies are shearingly engageable. The blind trimming apparatus further comprises a second pair of opposable cutting dies, at least one of which is moveable relative to the frame between a retracted position, in which the second pair of opposable cutting dies are spaced-apart, and an extended position, in which the second pair of opposable cutting dies are shearingly engageable and spaced from the first pair of opposable cutting dies when the first pair of opposable cutting dies are in the extended position. The blind trimming apparatus also comprises a third pair of opposable cutting dies, at least one of which is moveable relative to the frame between a retracted position, in which the third pair of opposable cutting dies are spaced-apart, and an extended position, in which the third pair of opposable cutting dies are shearingly engageable and spaced from the second pair of opposable cutting dies when second pair of opposable cutting dies are in the extended position. The second pair of opposable cutting dies are moveable with respect to the frame to vary the distance between the first pair of opposable cutting dies in the extended position and the second pair of opposable cutting dies in the extended position and are moveable with respect to the frame to vary the distance between the second pair of opposable cutting dies in the extended position and the third pair of opposable cutting dies in the extended position.

In another embodiment, the present invention provides a blind trimming apparatus comprising a frame supporting one of a first pair of opposable cutting dies and a carriage supporting a second pair of opposable cutting dies and another of the first pair of opposable cutting dies for sliding movement relative to the frame and along a first cutting path. One of the second pair of opposable cutting dies is pivotable relative to the carriage and is moveable along a second cutting path to engage another of the second pair of opposable cutting dies.

The invention also provides a method of trimming a blind assembly including a first blind element and a second blind element. The method includes the act of providing a blind trimming apparatus including a first pair of opposable cutting dies movable between a retracted position and an extended position, a second pair of opposable cutting dies moveable between a retracted position and an extended position, the second pair of opposable cutting dies being spaced from the first pair of opposable cutting dies when the first pair of opposable cutting dies are in the extended position, and a carriage supporting the second pair of opposable cutting dies. The method further including the acts of inserting the first blind element between the first pair of opposable cutting dies, moving the carriage to vary the distance between the first pair of opposable cutting dies in the extended position and the second pair of opposable cutting dies in the extended position, inserting the second blind element between the second pair of opposable cutting dies, shearing the first blind element between the first pair of opposable cutting dies, and shearing the second blind element between the second pair of opposable cutting dies.

Independent features and independent advantages of the present invention will become apparent to those skilled in the art upon review of the following detailed description, claims, and drawings.

The present invention is further described with reference to the accompanying drawings, which show at least one preferred construction of the present invention. However, it should be noted that the invention is explained and illustrated by way of example only. The various elements and combinations of elements described below and illustrated in the drawings can be arranged and organized differently to result in constructions which are still within the spirit and scope of the present invention. Also, it is understood that the phraseology and terminology used herein is for the purpose of description and should not be regarded as limiting.

### BRIEF DESCRIPTION OF THE DRAWINGS

In the drawings, wherein like reference numerals indicate like parts:

FIGS. 1A and 1B are perspective views of a blind trimming apparatus, including an adjustable blade arrangement, embodying aspects of the invention.

FIG. 2 is an enlarged sectional view of the blind trimming apparatus taken along line II-II in FIG. 1A.

FIG. 2A is perspective view of a conventional venetian blind.

FIG. 3 is an exploded view of a portion of the blind trimming apparatus shown in FIGS. 1A and 1B.

FIG. 4 is an enlarged perspective view of a first carriage of the adjustable blade arrangement shown in FIGS. 1A and 1B.

FIGS. 5A-5C are enlarged perspective views of a portion of the blade arrangement shown in FIGS. 1A and 1B.

FIG. 6 is an enlarged perspective view of a second carriage of the adjustable blade arrangement shown in FIGS. 1A and 1B.

FIG. 7 is an enlarged perspective view of a cutting blade of the adjustable blade arrangement shown in FIGS. 1A and 1B.

FIG. 8 is a perspective view of the underside of a first shuttle of the adjustable blade arrangement shown in FIGS. 1A and 1B.

FIG. 9 is a perspective view of a second shuttle of the adjustable blade arrangement shown in FIGS. 1A and 1B.

FIG. 10 is an enlarged perspective view of a support plate of the adjustable blade arrangement shown in FIGS. 1A and 1B.

FIG. 11 is an enlarged perspective view of a guide rail follower of the adjustable blade arrangement shown in FIGS. 1A and 1B.

FIG. 12 is an enlarged perspective view of a fastener of the adjustable blade arrangement shown in FIGS. 1A and 1B.

### DETAILED DESCRIPTION

The terms “first”, “second”, and “third”, and the terms “horizontal” and “vertical” are used herein and in the appended claims for purposes of description only and are not intended to imply any particular orientation, order, or importance.

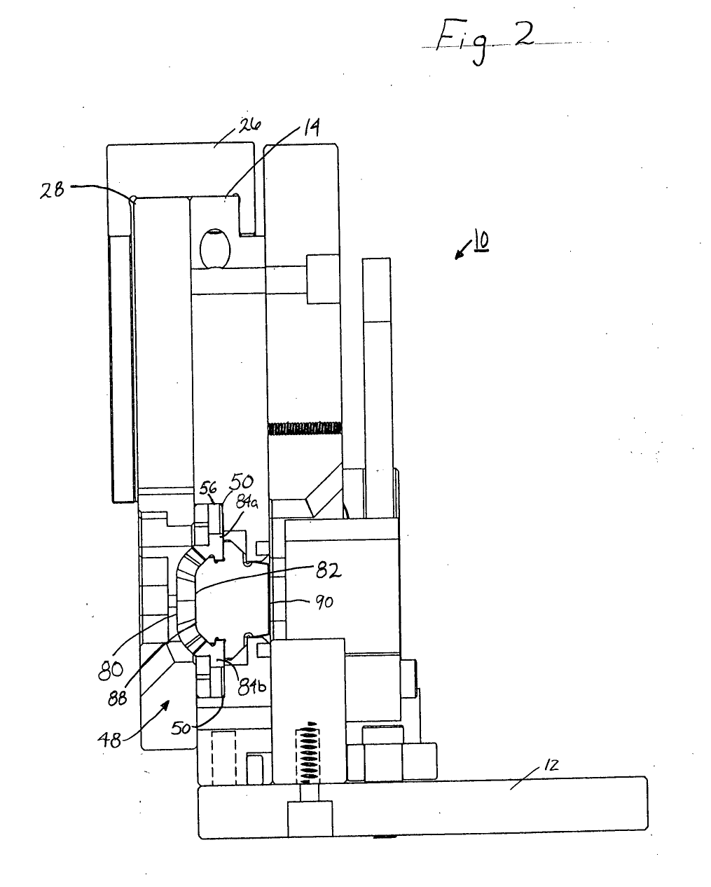

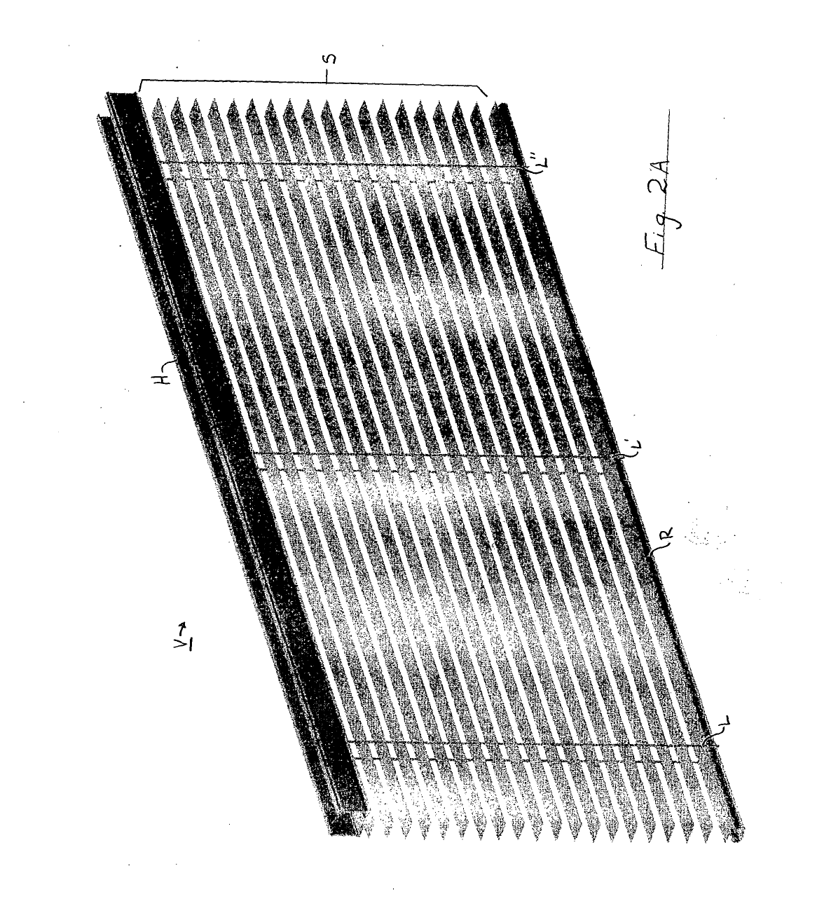

The drawings illustrate a blind trimming apparatus 10 which embodies the invention and which is adapted to trim a blind assembly V to length. FIG. 2A illustrates a conventional venetian blind V having a headrail H, a bottom rail R, three spaced-apart vertically extending ladders L, L′, L″ extending between the headrail H and bottom rail R, and a number of slats S supported by the ladders L, L′, L″. While the present invention is described herein as being used to trim venetian blinds V having a headrail H, a bottom rail R, and slats S in a single operation, one having ordinary skill in the art will appreciate that the apparatus 10 can be used to trim the individual elements of the blinds, e.g., the bottom rail R, all of the slats S, individual slats S, and the headrail H. Additionally, one having ordinary skill in the art will appreciate that the apparatus 10 can also be used to trim other window coverings.

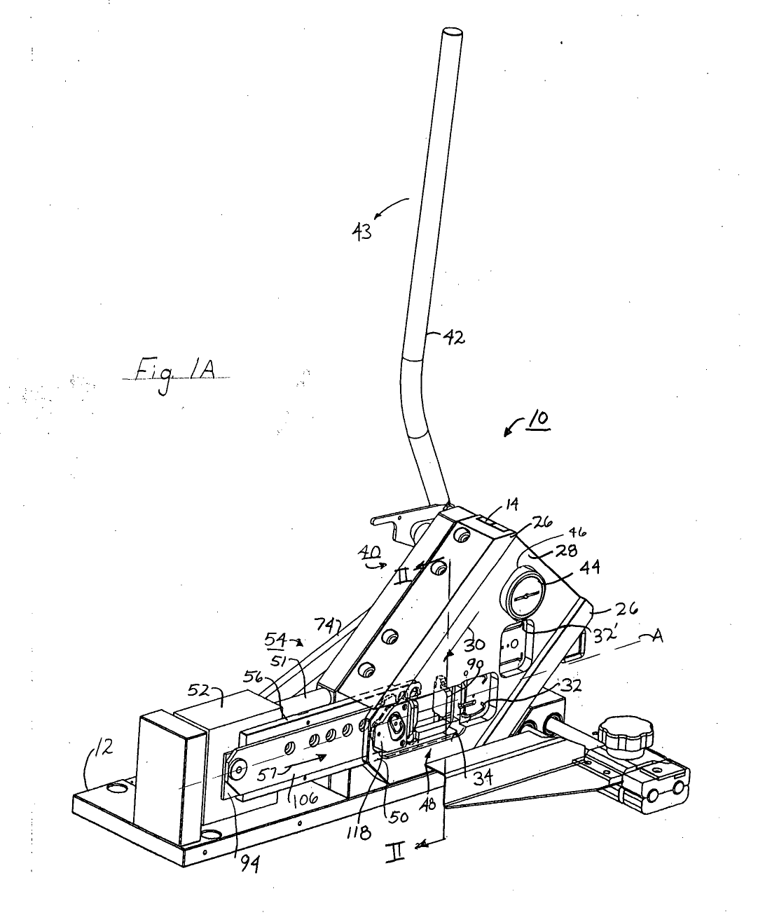

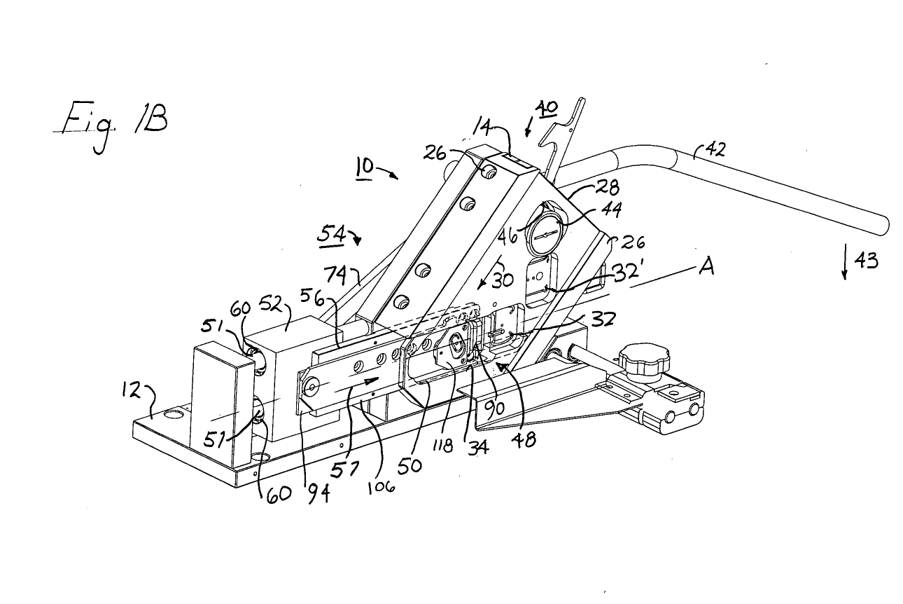

The blind trimming apparatus 10 is illustrated in FIGS. 1A, 1B, 2, and 3. Portions of the illustrated blind trimming apparatuses 10 are similar to conventional blind trimming apparatus, such as those disclosed in U.S. Pat. Nos. 5,806,394, 6,178,857, and 6,196,099 and Published U.S. patent application Ser. No. 2001/0054338, which disclosures are incorporated herein by reference. However, one having ordinary skill in the art will appreciate that the blind trimming apparatus 10 can successfully take other shapes and configurations.

The blind trimming apparatus 10 includes a base plate 12 and a frame 14 extending upwardly from the base plate 12 and having opposite sides 15 and 17. The frame 14 provides first cutting recesses or cutting dies 16, 16′ and a second cutting recess 18 that extend through the frame 14 between sides 15 and 17. An axis A (see FIG. 1) extends through the frame 14 and the first aperture 16.

The frame 14 and a pair of guides or rails 26 support a first carriage or die plate 28 for sliding movement along a first cutting path (represented by arrow 30 in FIGS. 1A and 1B) between a first retracted position (shown in FIG. 1A) and a first extended position (shown in FIG. 1B). In the illustrated construction, the first cutting path 30 is linear and intersects the axis A at an angle of approximately 45. However, it will be readily understood that in other constructions the first carriage 28 can be arranged to successfully move along other cutting paths, such as an arcuate path, a horizontal path, a vertical path, and the like.

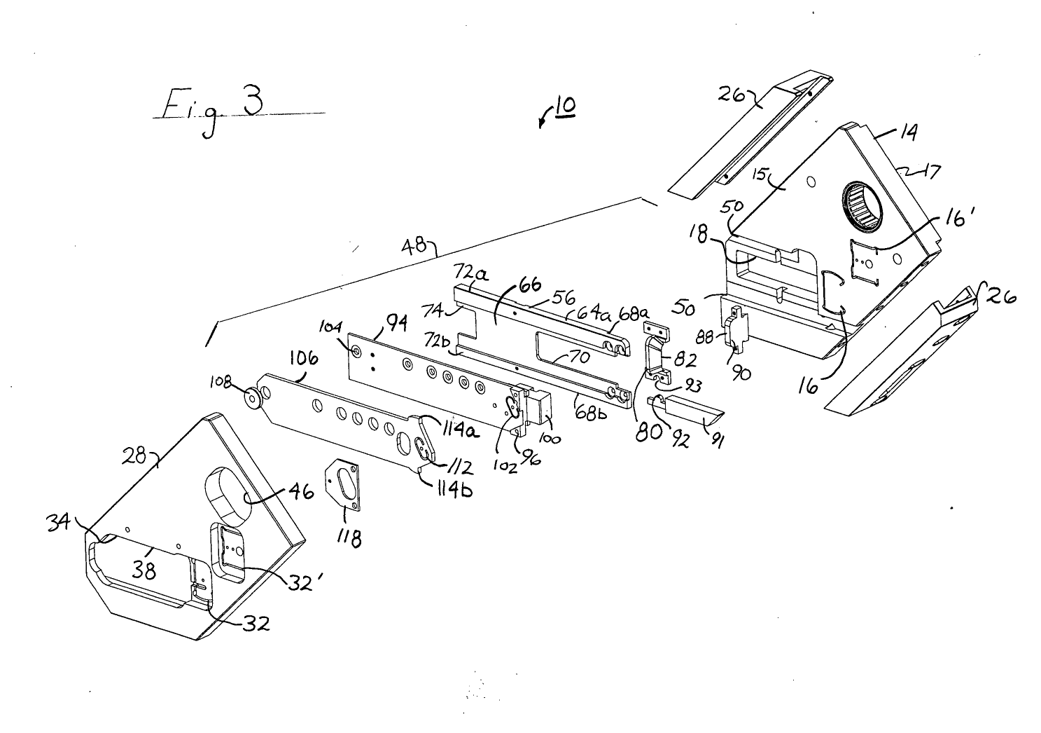

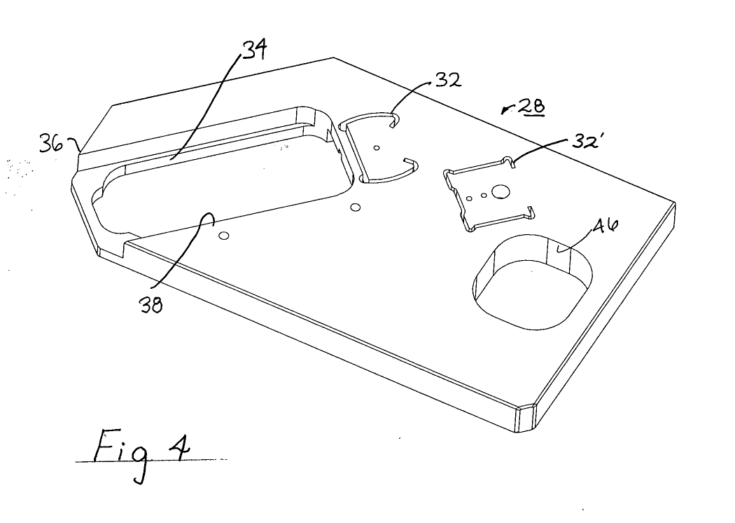

As shown in FIGS. 1A, 1B, 3 and 4, the first carriage 28 defines first recesses or cutting dies 32, 32′ and a second recess 34. Additionally as shown in FIG. 4, a slot 36 extends laterally through the first carriage 28 and communicates with the second recess 34. The circumference of the second recess 34 defines a first engagement surface 38.

The first recesses 32, 32′ are configured to correspond to the first apertures 16, 16′ and both the first recess 32 and the first aperture 16 are configured to receive a substantially C-shaped first blind element (e.g., a headrail H). Together, the first recess 32 and the first aperture 16 form a first pair of opposable cutting dies for trimming the first blind element. The first recess 32′ and the first aperture 16′ form an alternate first pair of opposable cutting dies for trimming a differently configured first blind element. More particularly, in applications in which the first blind element has a first configuration, an operator inserts the first blind element into the first aperture 16 and the first recess 32. In applications in which the first blind element has a second configuration, an operator inserts the first blind element into the first aperture 16′ and the first recess 32′. In other constructions (not shown), the first apertures 16, 16′ and the first recesses 32, 32′ can have other shapes and configurations, which correspond to the shapes and configurations of other blind elements (e.g., the slats S and/or the bottom rails R).

The blind trimming apparatus 10 also includes a drive assembly 40 that is operable to move the first carriage 28 along the first cutting path 30. The drive assembly 40 includes a handle or lever 42 fixed to an eccentric cam 44 and operable to pivot the eccentric cam 44 into engagement with an aperture 46 in the first carriage 28. In this manner, when the handle 42 is pivoted downwardly (i.e., in the direction of arrow 43 in FIGS. 1A and 1B) from a first position (shown in FIG. 1A) to a second position (shown in FIG. 1B), the eccentric cam 44 pivots into engagement with a lower edge of the aperture 46, causing the first carriage 28 to move downwardly along the first cutting path 30 toward the first extended position to cut the first blind element (e.g., the headrail H). After the first blind element is cut, the handle 42 can be moved from the second position back to the first position to move the first carriage 28 back to the retracted position.

The blind trimming apparatus 10 also includes a blade arrangement 48, which includes a second carriage 56. The frame 14 defines guides or rails 50 which extend laterally along a surface of the frame 14 in a direction substantially parallel to the axis A. The second carriage 56 is slideably mounted on the rails 50 for movement along a second cutting path (represented by arrow 57 in FIGS. 1A and 1B) between a second retracted position (shown in FIG. 1A) and a second extended position (shown in FIG. 1B). Additionally, the blind trimming apparatus 10 includes a second drive assembly 54 that is operable to move the second carriage 56 between the second retracted position and the second extended position.

As shown in FIGS. 1A and 1B, the second drive assembly 54 includes two spaced-apart cylindrical rails 51 and a follower 52 with two parallel through-holes 60. The rails 51 extend through the through-holes 60 in the follower 52 to guide movement of the follower 52. The second carriage 56 includes a rearwardly extending protrusion (not shown), which is engageable in a corresponding recess (not shown) in the follower 52 to selectively couple the second carriage 56 to the follower 52. In this manner, when the second carriage 56 is connected to the follower 52, the second drive assembly 54 is operable to guide the second carriage 56 between the second retracted position and the second extended position. During die adjustment operations (described below), an operator can disengage the second carriage 56 from the follower 52 to move the second carriage 56 independently along the axis A and can then reengage the second carriage 56 and the follower 52 for further trimming operations.

The second drive assembly 54 also includes a connecting rod 74 operably connected to the first drive assembly 40 so that operation of the handle 42 moves the second carriage 56 between the second retracted position and the second extended position. In this manner, an operator can move both the first and second carriages 28, 56 between retracted and extended positions with a single movement of the handle 42. Alternatively, though not shown, the first and second drive assemblies 40, 54 can be independently operable so that the first and second carriages 28, 56 can be moved independently between the first and second retracted and extended positions, respectively.

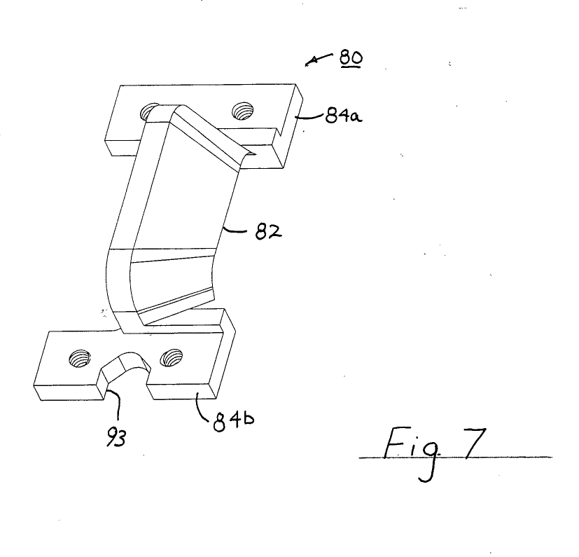

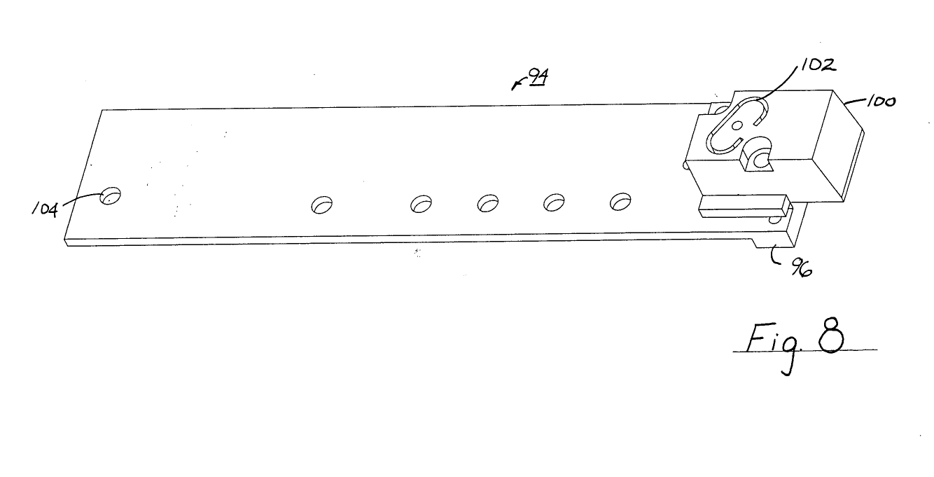

As shown in FIGS. 3 and 6, the second carriage 56 is generally H-shaped and includes a pair of legs 64a, 64b and a central cross bar 66 extending between the legs 64a, 64b. Together, the cross bar 66 and forwardly extending portions 68a, 68b of the legs 64a, 64b define a forward internal space 70 and the cross bar 66 and rearwardly extending portions 72a, 72b of the legs 64a, 64b define a rearward internal space 74. As best shown in FIG. 6, the undersides of the forwardly extending portions 68a, 68b of the legs 64a, 64b define blade recesses 78a, 78b.

The blade arrangement 48 also provides a cutting die or cutting blade 80 (shown in FIG. 7), which includes a cutting edge 82 and outwardly extending flanges 84a, 84b. The outwardly extending flanges 84a, 84b are supported in the blade recesses 78a, 78b, respectively.

As shown in FIGS. 1A, 1B, 2, and 3, the blade arrangement 48 also includes a die or cutting tool 90, which extends outwardly from the frame 14 into the second cutting recess 18 of the frame 14. Together, the cutting blade 80 and the cutting tool 90 define a second pair of opposable cutting dies and are operable to trim a second blind element (e.g., the blind slats S). More particularly, the cutting edge 88 of the cutting tool 90 is configured to closely engage the cutting edge 82 of the cutting blade 80. One having ordinary skill in the art will appreciate that in other aspects and in other constructions (not shown), the blade arrangement 48 of the present invention can alternately include one, two, three, or more cutting tools 90.

The cutting tool 90 has a generally arcuately shaped cutting edge 88 that is shaped to correspond to the generally arcuately shaped cutting edge 82 of the cutting blade 80. More particularly, as described in detail below, the cutting edge 88 of the cutting tool 90 is shaped to closely engage the cutting edge 82 of the cutting blade 80 to shear a second blind element (e.g., blind slats S) during trimming. Of course, the cutting edges 82, 88 of the cutting blade 80 and the cutting tool 90 could also have other, corresponding shapes to provide different blind element configurations (e.g., dog-eared, pointed, and the like) but are preferably similarly shaped to facilitate a shearing-interaction of the edges 82, 88 during trimming operations.

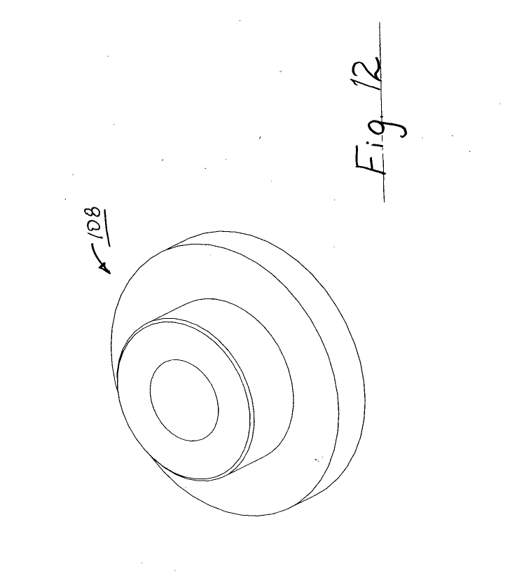

As shown in FIGS. 3, 5A-5C, and 11, the second carriage 56 includes an elongated guide rail follower 91. A rearward end of the guide rail follower 91 extends into one of the blade recesses 78a, 78b (e.g., blade recess 78b) and is secured to the second carriage 56 by one of the flanges 84a of the cutting blade 80. Additionally, the rearward end of the guide rail follower 91 includes a protrusion 92. The protrusion 92 is matingly received in a corresponding recess 93 in the blade flange 84b. During operation, the guide rail follower 91 travels along one of the guides 50 in a direction generally parallel to the axis A and supports the second carriage 56 for sliding movement along the second cutting path 57. Additionally, the guide rail follower 91 prevents debris, e.g., blind slat trimmings and the like, from falling into and possibly jamming the guides 50.

When the cutting blade 80 becomes worn and/or requires replacement, the cutting blade 80 can be removed from the second carriage 56. Additionally, to facilitate removal of the cutting blade 80 and to provide additional work space for blade replacement, the guide rail follower 91 is also removable. Moreover, because the guide rail follower 91 is secured to the second carriage 56 by the cutting blade 80, when the cutting blade 80 is released from the second carriage 56, the guide rail follower 91 is simultaneously or nearly simultaneously disconnected from the second carriage 56.

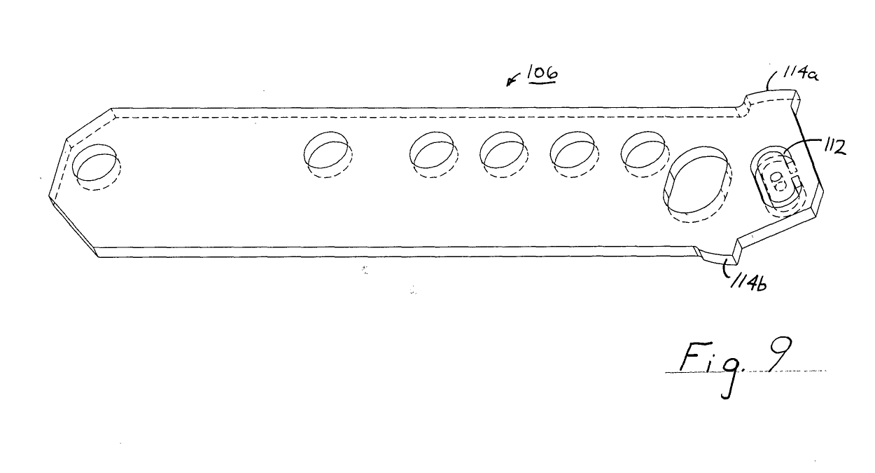

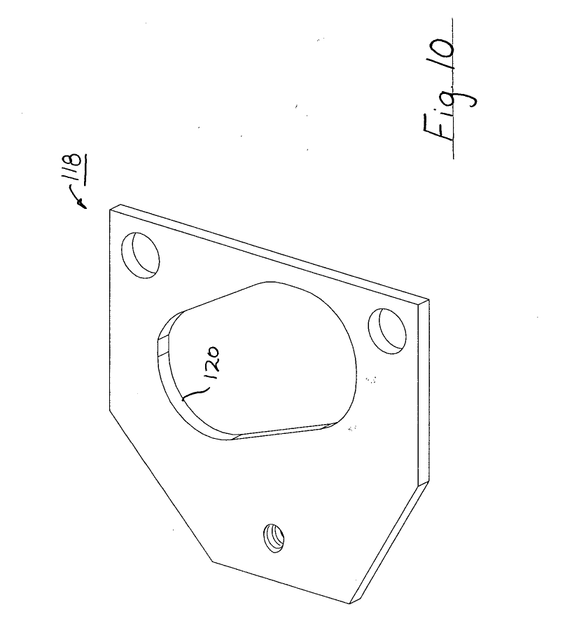

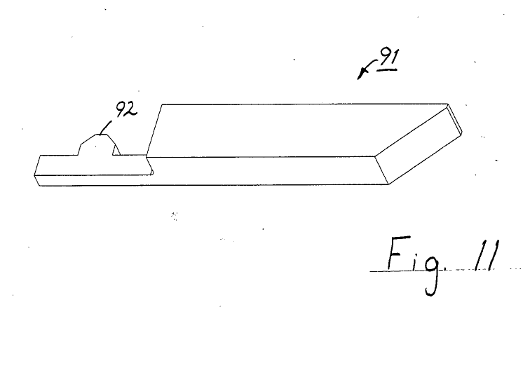

As shown in FIGS. 3, 5A-5C, and 8, the blade arrangement 48 also includes a first shuttle 94 that is supported by the second carriage 56 for sliding movement between the legs 64a, 64b and along the axis A relative to the carriage 56. A front side of the first shuttle 94 includes a first outwardly extending protrusion 96 and a back side of the first shuttle 94 includes a second outwardly extending protrusion 100. The first shuttle 94 also defines a cutting die 102 in the form of a substantially C-shaped aperture, which extends through the front side of the first shuttle 94 and the second outwardly extending protrusion 100. However, in other constructions (not shown), the cutting die 102 can have other shapes and configurations. The second outwardly extending protrusion 100 is configured to engage the forward internal space 70 of the second carriage 56 to limit sliding motion of the first shuttle 94 along the second carriage 56. The first shuttle 94 also includes a through-hole 104.

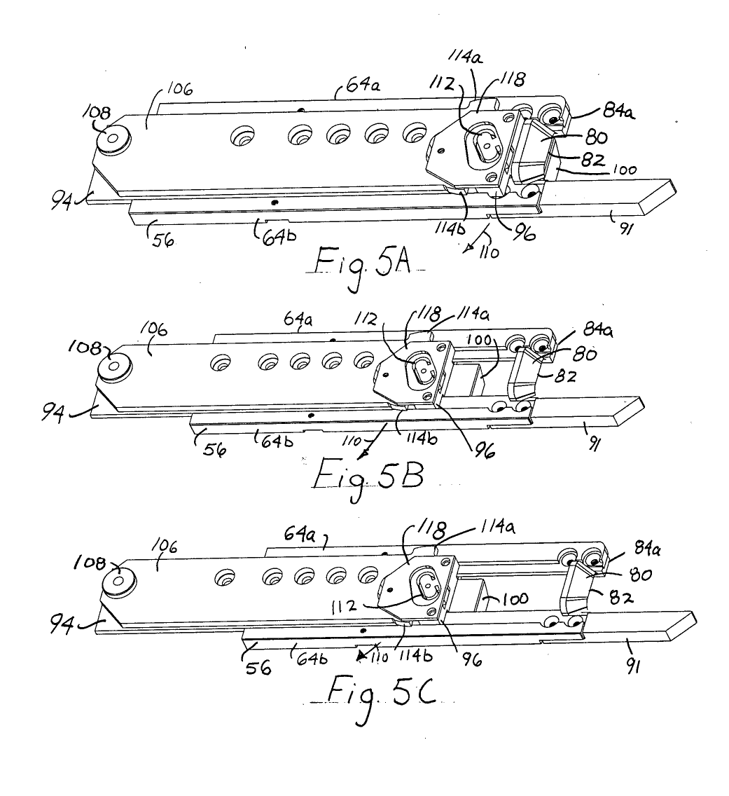

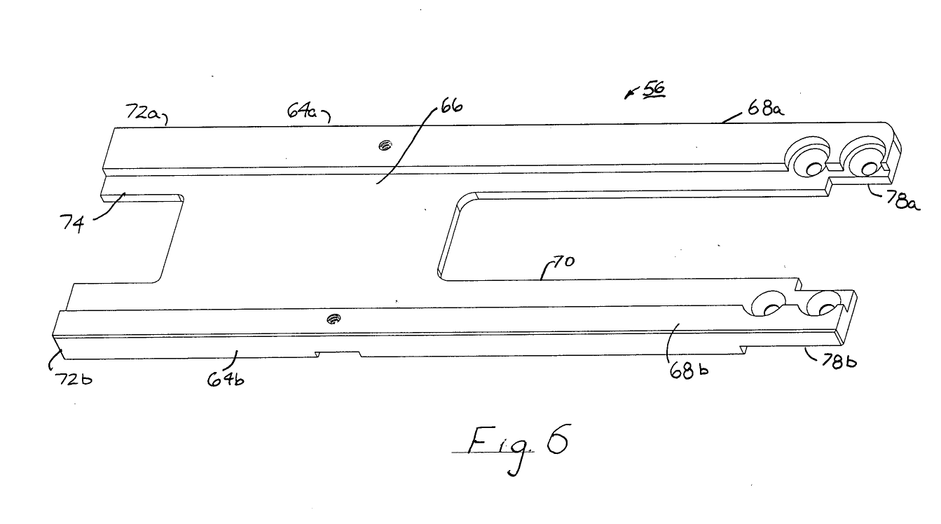

The second carriage 56 also supports a second shuttle 106 and a fastener 108 (shown in FIGS. 3, 5A-5C, and 12) that pivotably couples the second shuttle 106 to the first shuttle 94 for movement along a third cutting path (represented by arrow 110 in FIGS. 5A-5C). A forward end of the second shuttle 106 defines a cutting die 112 and outwardly extending flanges 114a, 114b. Together, the cutting dies 102, 112 form a third pair of opposable cutting dies and are operable to trim a third blind element (e.g., bottom rails R).

A die plate 118 is connected (e.g., with conventional fasteners, such as, bolts, screws, and the like) to the first outwardly extending protrusion 96 and is operable to prevent the second shuttle 106 from moving outwardly away from the second carriage 56 and the first shuttle 94. The die plate 118 also defines a central aperture 120 that communicates with the first and second cutting dies 102, 112.

During operation of the trimming apparatus 10, an operator moves the first and second carriages 28, 56 to the first and second retracted positions (as shown in FIG. 1A). The operator then inserts a first blind element (e.g., the headrail H) between the first pair of opposable cutting dies (e.g., the first aperture 16 and the first recess 32), inserts a second blind element (e.g., the slats S) between the second pair of opposable cutting dies (e.g., the cutting blade 80 and the cutting tool 90), and inserts a third blind element (e.g., the bottom rail R) between the third pair of opposable cutting dies (e.g., cutting dies 102, 112).

Conventional blinds V generally have a number of different sizes and configurations. Similarly, conventional blinds V often have different vertical lengths or “drops” that correspond to the height of the window. Generally, taller windows require blinds V having a longer drop and shorter windows require blinds V having a shorter drop. Blinds V having a longer drop generally include a larger number of slats S than blinds V having a shorter drop. Additionally, blind slats S are made of a number of different materials (e.g., aluminum, wood, plastics, vinyl, and the like) and each of the materials generally has a different thickness. Therefore, the second pair of opposable cutting dies (e.g., the cutting blade 80 and the cutting tool 90) are adjustable to accommodate blinds V having different drops and blinds V having slats S made of a number of different conventional materials. More particularly, the cutting blade 80 is moveable with the second carriage 56 along the axis A alternately away from and toward the cutting tool 90 to adjust the relative distance between the cutting blade 80 and the cutting tool 90.

Therefore, the operator can adjust the relative positions of the second pair of opposable cutting dies (e.g., the cutting blade 80 and the cutting tool 90) to accommodate the blind slats S. In a similar manner, the operator can adjust the relative location of the third pair of opposable cutting dies (e.g., the cutting die 102 and the cutting die 112). As explained above, ladders L, L′, L″ extend between the headrail H and the bottom rail R and support the blind slats S. In most cases, the distance between the lower-most blind slat and the bottom rail R is maintained by the ladders L, L′, L″. Therefore, the third pair of opposable cutting dies (e.g., the cutting die 102 and the cutting die 112) is also adjustable relative to the first and second and pairs of opposable cutting dies (e.g., the first aperture 16 and the first recess 32 and the cutting blade 80 and the cutting tool 90) to accommodate differently sized and differently configured blinds V.

To adjust the relative position of the third pair of opposable cutting dies, the operator can slide the first and second shuttles 94, 106 along second carriage 56 and along the axis A alternately toward and away from the cutting tool 90. In applications in which the distance between the headrail H and the bottom rail R is relatively small and the drop of the blinds V is relatively short, the operator moves the first and second shuttles 94, 106 along the second carriage 56 toward the cutting tool 90. Alternatively, in applications in which the distance between the headrail H and the bottom rail B is relatively large and the drop of the blinds V is relatively large, the operator moves the first and second shuttles 94, 106 along the second carriage 56 away from the cutting tool 90.

Once the operator has inserted the blind elements (e.g., the headrail H, the bottom rail R, and the slats S) between the appropriate pairs of opposable cutting dies and has adjusted the relative positions of the opposable cutting dies, the operator operates the first and second drive assemblies 40, 54 to move the first and second carriages 28, 56. In the illustrated construction, the operator pivots the handle 42 (e.g., in a counter clockwise direction as indicated by arrow 43 in FIGS. 1A and 1B), moving the first and second carriages 28, 56 along the first and second cutting paths 30, 57, respectively. As described above, as the first carriage 28 moves along the first cutting path 41, the first carriage 28 cooperates with the frame 14 to shear the first blind element (e.g., the headrail H) between the first pair of opposable cutting dies (e.g., between the first aperture 16 and the first recess 32).

As the second carriage 56 moves along the second cutting path 57, the cutting edge 82 of the cutting blade 80 engages the second blind element (e.g., individual slats S) located in aperture 20. Lateral motion of the cutting blade 80 along the second cutting path 57 causes the cutting edge 82 to cut through or trim the second blind element. As shown in FIG. 1B, as the second carriage 56 continues along the second cutting path 57, the cutting blade 80 engages the cutting tool 90 to complete the trimming of the second blind element (e.g., trimming the final slats S).

Additionally, as the first and second carriages 28, 56 move along the first and second cutting paths 30, 57, the engagement surface 38 of the first carriage 28 is moved into engagement with the outwardly extending flange 114a of the second shuttle 106, causing the second shuttle 106 to pivot relative to the first shuttle 94 and along the third cutting path 110. In this manner, the third blind element (e.g., the bottom rail R) is sheared between the third pair of opposable cutting dies (e.g., cutting die 102 and cutting die 112).

The constructions and aspects described above and illustrated in the drawings are presented by way of example only and are not intended as a limitation upon the concepts and principles of the present invention. As such, it will be appreciated by one having ordinary skill in the art, that various changes in the elements and their configuration and arrangement are possible without departing from the spirit and scope of the present invention as set forth in the appended claims.

1. A blind trimming apparatus comprising:
a frame;
a first pair of opposable cutting dies, at least one of which is moveable relative to the frame between a retracted position, in which the first pair of opposable cutting dies are spaced-apart, and an extended position, in which the first pair of opposable cutting dies are shearingly engageable;
a second pair of opposable cutting dies, at least one of which is moveable relative to the frame between a retracted position, in which the second pair of opposable cutting dies are spaced-apart, and an extended position, in which the second pair of opposable cutting dies are shearingly engageable and spaced from the first pair of opposable cutting dies when the first pair of opposable cutting dies are in the extended position; and
a carriage supported by the frame and supporting the second pair of opposable cutting dies, the carriage being moveable with respect to the first pair of opposable cutting dies to vary the distance between the first pair of opposable cutting dies in the extended position and the second pair of opposable cutting dies in the extended position.

2. The blind trimming apparatus of claim 1, further comprising a third pair of opposable cutting dies moveable between a retracted position, in which the third pair of opposable cutting dies are spaced-apart, and an extended position, in which the third pair of opposable cutting dies are shearingly engageable.

3. The blind trimming apparatus of claim 2, wherein the third pair of opposable cutting dies are spaced from the second pair of opposable cutting dies when the third pair of opposable cutting dies are in the extended position, and wherein the carriage is moveable with respect to the third pair of opposable cutting dies to vary the distance between the second pair of opposable cutting dies in the extended position and the third pair of opposable cutting dies in the extended position.

4. The blind trimming apparatus of claim 1, further comprising a shuttle moveably connected to the carriage, the shuttle supporting one of the second pair of opposable cutting dies for movement relative to the carriage.

5. The blind trimming apparatus of claim 4, further comprising a second shuttle pivotably connected to the first shuttle, the second shuttle supporting an other of the second pair of opposable cutting dies for pivoting movement relative to the first shuttle.

6. The blind trimming apparatus of claim 1, further comprising a frame supporting one of the first pair of opposable cutting dies, and wherein the carriage supports an other of the first pair of opposable cutting dies for movement with the carriage along a first cutting path.

7. The blind trimming apparatus of claim 6, wherein one of the second pair of opposable cutting dies is pivotable relative to the carriage for movement along a second cutting path.

8. The blind trimming apparatus of claim 1, wherein the frame defines a guide rail, and wherein the carriage is moveable along the guide rail and includes a removeable guide rail follower.

9. A blind trimming apparatus comprising:
a frame;
a first pair of opposable cutting dies, at least one of which is moveable relative to the frame between a retracted position, in which the first pair of opposable cutting dies are spaced-apart, and an extended position, in which the first pair of opposable cutting dies are shearingly engageable;
a second pair of opposable cutting dies, at least one of which is moveable relative to the frame between a retracted position, in which the second pair of opposable cutting dies are spaced-apart, and an extended position, in which the second pair of opposable cutting dies are shearingly engageable and spaced from the first pair of opposable cutting dies when the first pair of opposable cutting dies are in the extended position; and
a third pair of opposable cutting dies, at least one of which is moveable relative to the frame between a retracted position, in which the third pair of opposable cutting dies are spaced-apart, and an extended position, in which the third pair of opposable cutting dies are shearingly engageable and spaced from the second pair of opposable cutting dies when second pair of opposable cutting dies are in the extended position, the second pair of opposable cutting dies being moveable with respect to the frame to vary the distance between the first pair of opposable cutting dies in the extended position and the second pair of opposable cutting dies in the extended position and being moveable with respect to the frame to vary the distance between the second pair of opposable cutting dies in the extended position and the third pair of opposable cutting dies in the extended position.

10. The blind trimming apparatus of claim 9, further comprising a carriage supporting the second pair of opposable cutting dies, the carriage being moveable with respect to at least one of the first pair of opposable cutting dies to vary the distance between the first pair of opposable cutting dies in the extended position and the second pair of opposable cutting dies in the extended position.

11. The blind trimming apparatus of claim 10, further comprising a shuttle moveably connected to the carriage, the shuttle supporting one of the second pair of opposable cutting dies for movement relative to the carriage.

12. The blind trimming apparatus of claim 11, further comprising a second shuttle pivotably connected to the first shuttle, the second shuttle supporting an other of the second pair of opposable cutting dies for pivoting movement relative to the first shuttle.

13. The blind trimming apparatus of claim 10, further comprising a frame supporting one of the first pair of opposable cutting dies, and wherein the carriage supports an other of the first pair of opposable cutting dies for movement with the carriage along a first cutting path.

14. The blind trimming apparatus of claim 13, wherein one of the second pair of opposable cutting dies is pivotable relative to the carriage for movement along a second cutting path.

15. The blind trimming apparatus of claim 13, wherein the frame defines a guide rail, and wherein the carriage is moveable along the guide rail and includes a removeable guide rail follower.

16. A blind trimming apparatus comprising:
a frame supporting one of a first pair of opposable cutting dies; and
a carriage supporting a second pair of opposable cutting dies and an other of the first pair of opposable cutting dies for sliding movement relative to the frame and along a first cutting path, one of the second pair of opposable cutting dies being pivotable relative to the carriage and being moveable along a second cutting path to engage an other of the second pair of opposable cutting dies.

17. The blind trimming apparatus of claim 16, further comprising a second carriage slideably connected to the frame and moveable along a third cutting path, the second carriage being engageable with the one of the second pair of opposable cutting dies to move the one of the second pair of opposable cutting dies along the second cutting path.

18. The blind trimming apparatus of claim 17, wherein the frame supports one of a third pair of opposable cutting dies and the second carriage supports an other of the third pair of opposable cutting dies.

19-21 (Cancelled)
